(19) United States
(12) Patent Application Publication
(10) Pub. No.: US 2004/0060464 A1
(43) Pub. Date: Apr. 1, 2004

(54) Method of cross-cutting a web

(75) Inventors: Andreas Birkenfeld, Dinkelscherben (DE); Peer Dilling, Friedberg (DE); Robert Kersch, Augsburg (DE); Wolfgang Zeller, Gersthofen (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG

(21) Appl. No.: 10/668,773

(22) Filed: Sep. 22, 2003

(30) Foreign Application Priority Data
Sep. 27, 2002 (DE) 102 45 322.5

(51) Int. Cl. B41F 13/56

(52) U.S. Cl. 101/226

(57) ABSTRACT

In order to provide good format variability of printed products and economic utilization of the printing material, a web is supplied to a cross-cutting device and cut up into sheets with different cut lengths corresponding to heights of printed pages in a sequence.

### BACKGROUND OF THE INVENTION

1. Field of the Invention

The invention relates to method of cross-cutting a web.

2. Description of the Related Art

A web printed by a web-fed rotary press is printed in its running direction with a sequence of equal-height printed pages. The height of the printed pages is normally equal to the circumference or half the circumference of the plate cylinder of the press. The further processing of the web generally comprises winding up the web or cross-cutting the web into equal-length sheets, the delivery and stacking or folding of these equal-length sheets.

It is additionally known to divide up the circumferential format of a press into equal-length sub-formats. Here, too, during the further processing of the web, equal-height sheets are cut in accordance with the height of the sub-format.

During this processing, it is a disadvantage that the print shop is limited in terms of the choice of format, or the printed pages of the printing plate which are available are poorly utilized. For example, it is normally sufficient to print marks for control and regulation purposes only once per plate cylinder revolution, that is to say to provide a control strip containing these marks only in one printed page. In the further printed pages, this region then remains unused.

### SUMMARY OF THE INVENTION

It is an object of the invention to provide a method of cross-cutting a web which permits good format variability of the printed products and economic use of the printing material.

According to the invention, a web having a repeated sequence of at least two printed pages with different heights is fed in a running direction to a cross-cutting device, where it is cut transversely to the running direction to form sheets having section lengths corresponding to the heights The invention makes it possible to process webs to form printed products with a wide format variability.

### BRIEF DESCRIPTION OF THE DRAWINGS

FIG. 1 shows a cross-cutting device on a web which is supplied from a web-fed rotary press,

FIG. 2 shows an unwind device which outputs a web,

FIG. 3 shows a cross-cutting device operating with a laser beam.

### DETAILED DESCRIPTION OF THE PRESENTLY PREFERRED EMBODIMENTS

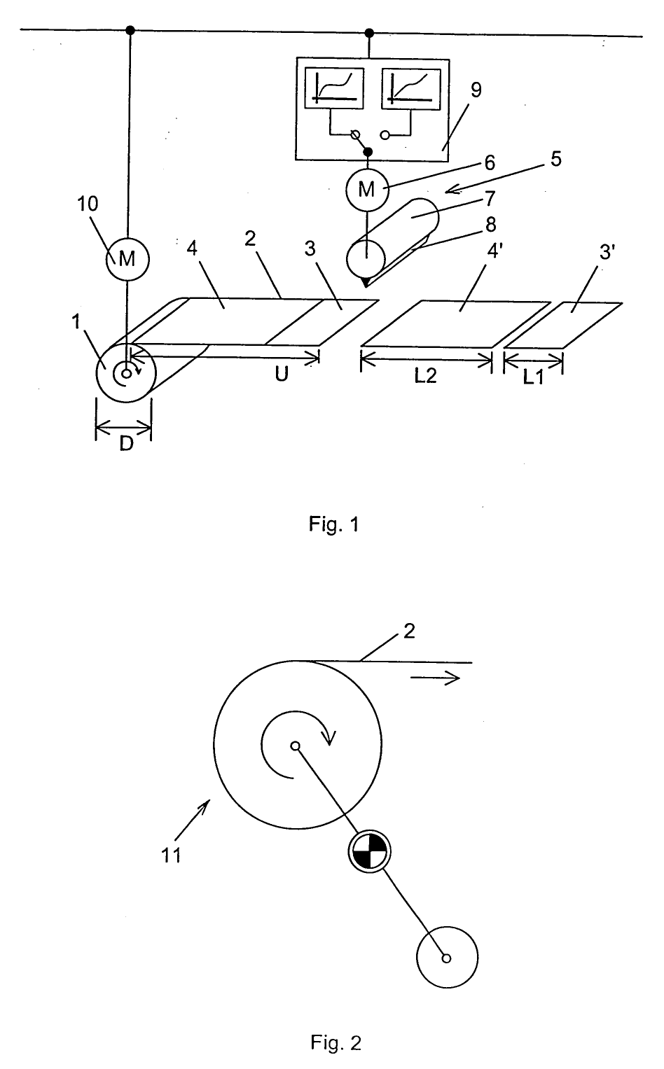

In FIG. 1, only a plate cylinder 1 of a web-fed rotary press is illustrated, by which printed images from a printing plate are printed onto a web 2. In the exemplary embodiment, the plate cylinder 1 prints the printed pages 3 and 4 onto the web 2 during a revolution. The addition of the heights L1 and L2 of the printed pages 3 and 4 therefore supplies the circumference U of the plate cylinder 1 with a diameter D, and the relationship

U=Π×D=L1+L2

is therefore true.

The printed web 2 is supplied to a cross-cutting device 5, which has a knife cylinder 7 driven by a motor 6. The knife cylinder 7 is fitted with at least one cutting knife 8 which rotates about an axis parallel to a cutting line. The motor controller of the motor 6 of the knife cylinder 7 is connected to the output from a computing and storage unit 9, which is additionally connected to a motor 10 for the drive of the plate cylinder 1.

During the cut, the knife cylinder 7 is operated at a circumferential speed corresponding approximately to the web speed. In this case, the cutting knife 8 interacts with an opposing knife, not illustrated. A plurality of cutting knives 8 can also be arranged on the knife cylinder 7, it being possible for the circumferential spacing between two cutting knives that cut successively to be dimensioned differently from the cut length. After a cut has been carried out, the next cut length is predefined to the motor 6 of the knife cylinder 7 in accordance with the height L1 or L2 of the printed page 3 or 4 to be cut off. In detail, the motor 6 has a movement sequence predefined which is selected from a memory of the computing and storage unit 9. Movement sequences of this type are entered symbolically in the figure at the computing and storage unit 9. For example, after a printed page 3 has been cut off, a printed sheet 3′ being produced, a cut length which corresponds to the height L2 of the printed page 4 to be cut off is predefined by means of the computing and storage unit 9. For this purpose, the motor 6 has a movement sequence predefined to it in such a way that its next cutting knife comes into use during an onward movement of the web 2 by the amount L2. The cut lengths are predefined in accordance with the variable format sequences.

In the case of the present supply of the web 2 from a press, the movement sequences for implementing the cut lengths are advantageously predefined in accordance with the rotary position of the plate cylinder 1 in a manner synchronized with the position of the web 2. For this purpose, the motor control of the motor 10 of the plate cylinder 1 is connected to the computing and storage unit 9 in a suitably communicating manner. This therefore ensures that the variable printed pages distributed over the cylinder circumference are also repeatedly cut off cyclically and the sequence of all the cuts is repeated. It is therefore possible for different formats or printed pages arranged on the circumference of the plate cylinder 1 to be processed. This makes it possible to make efficient use of that circumferential region of the plate cylinder which can be occupied by a printed image. For example, it is also possible to select regions differently for the printing of control and measuring marks. The web 2 can also be supplied to the cross-cutting device 5 from an unwind device 11, as shown in FIG. 2. Here, the synchronization of the knife cylinder 7 with the movement of the web 2 can then advantageously be implemented by using the drive to the roll which drives the web 2.

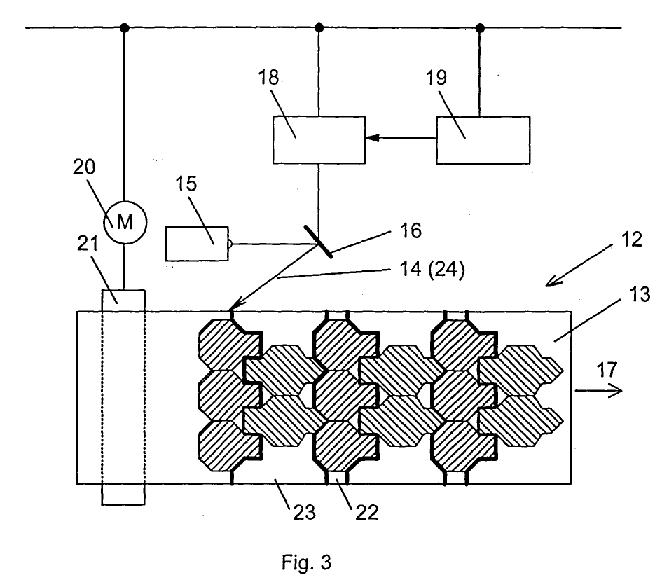

FIG. 3 shows a cross-cutting device 12 which uses a laser beam 14 to sever a web 13. In detail, the laser beam 14 is produced in a laser 15 and, by means of a deflection device 16, is deflected transversely with respect to the web 13 moving in the direction 17. The deflection is carried out by means of a deflection device 16, which is connected to a control device 18. Furthermore, the output from a memory 19 is led to the control device 18. In addition, the control device 18 is connected to a motor 20, which drives a roll 21 transporting the web 13.

For a cut, the web 13, which is transported by means of the roll 21 and which can be supplied directly from a press or an unwind device, is cross-cut by means of the laser beam 40. The latter is moved transversely with respect to the moving web 13 by means of the deflection device 16. In the process, a signal which takes into account the continuous change in the position of the web 13 is connected to the deflection device 16. The position of the web 13 is advantageously determined from the position of the motor 20 of the roll 21 transporting the web 13.

After a cut has been carried out, the control device 18 will predefine the next cut length in accordance with the height of the printed page to be cut off. These cut lengths are stored in the memory 19. If the web 13 has a sequence of printed pages, as shown in the case of the web 2 in FIG. 1, a rectilinear cut is made. However, by driving the deflection device 16 appropriately, contours differing from a straight line can also be cut, as shown on the web 13 in FIG. 3. In this case, a signal which takes account of the cutting contour is fed to the control device from the memory 19. The deflection device 16 is then driven by the control device 18 in such a way that, in order to implement the cut contour, the laser beam 14 is moved appropriately, leading and trailing the web movement. By means of the freely selectable point of action of the laser beam, the web 13 can be divided into sections 22, 23 with any desired external contour. By means of overlapping the cuts 22, 23, as shown by way of example in FIG. 3 and advantageously used in packaging printing, optimum utilisation of the printing area and of the printing material is possible.

A water jet 24 can also be used as a cutting tool instead of by means of a laser beam 14 (also indicated in FIG. 3 as a bracketed item). Such a water jet can be produced by a nozzle which is pivoted by means of a deflection device

The invention is not limited by the embodiments described above which are presented as examples only but can be modified in various ways within the scope of protection defined by the appended patent claims.

We claim:

1. A method of cross-cutting a web having a repeated sequence of at least two printed pages with different heights, said method comprising:
moving said web in a running direction; and
cutting said web transversely to said running direction successively by means of a cross-cutting device to form sheets having section lengths corresponding to said heights.

2. A method as in claim 1 wherein said cross-cutting device comprises a knife cylinder having at least one cutting knife which rotates about an axis parallel to a cutting line, said method comprising:
supplying said web at an approximately constant speed to said cross-cutting device;
driving said knife cylinder to rotate by means of a motor;
cutting said web to form a sheet by operating said knife cylinder, during cutting, at a circumferential speed corresponding approximately to the web speed;
selecting a movement sequence from a memory in accordance with the height of the next printed page to be cut; and
predefining said movement sequence to said motor so that the next sheet is cut with a section length corresponding to the height of the next printed page.

3. A method as in claim 2 further comprising:
printing said web in a web-fed rotary printing pressing having a plate cylinder driven by a motor controlled by a drive controller;
communicating the rotary position of the plate cylinder from the drive controller to a computing and storage unit comprising said memory; and
predefining the movement sequence for said motor of said knife cylinder in said computing and storage unit cyclically so that the position of the web is synchronized the rotary position of the plate cylinder.

4. A method as in claim 1 wherein said cross-cutting device comprises means for severing said web by means of a beam or a jet, said method comprising:
severing said web by aiming said beam or said jet toward said web by means of a deflection device;
selecting the height of the next printed page to be severed from a memory; and
controlling said deflection device so that the next sheet is cut with a section length corresponding to the height of the next printed page.

5. A method as in claim 4 further comprising:
providing a signal which takes into account the continuous position of the web; and
connecting said signal to said deflection device.

6. A method as in claim 4 further comprising:
providing a signal which takes into account the contour of a cut which differs from a straight line;
connecting said signal to said deflection device; and
deflecting beam or said jet in accordance with said contour, leading and trailing said running direction.

7. A method as in claim 4 wherein said cross-cutting device comprises means for severing said web by means of a laser beam.

8. A method as in claim 4 wherein said cross-cutting device comprises means for severing said web by means of a water jet.

9. A method as in claim 1 comprising feeding said web from a web-fed rotary press to said cross-cutting device.

10. A method as in claim 1 comprising feeding said web from an unwind device to said cross-cutting device.
